(19) United States
(12) Patent Application Publication
(10) Pub. No.: US 2011/0211037 A1
(43) Pub. Date: Sep. 1, 2011

(54) Conferencing System With A Database Of Mode Definitions

(76) Inventors: Otto A. Gygax, Philomath, OR (US); Deqing Hu, Corvallis, OR (US); Joseph Davis, Corvallis, OR (US)

(21) Appl. No.: 13/123,653

(22) PCT Filed: Oct. 15, 2008
(86) PCT No.: PCT/US08/80056

§ 371 Date: Apr. 11, 2011

(51) Int. Cl. H04N 7/15

(52) U.S. Cl. 348/14.08; 348/E07.083

(57) ABSTRACT

The present invention is embodied in an audio conferencing system for a computer system, including a database storing a plurality of mode definitions each indicative of a video conference session configuration (402) and an acoustic canceling subsystem operating on the computer system having an initial configuration running during a video conferencing session (406). An acoustic change to a new acoustic configuration of the video conferencing system is detected during the session (408), a mode definition is selected from the database based upon the new acoustic configuration and the echo canceling system is dynamically reconfigured based upon the new acoustic configuration during the session (410).

### BACKGROUND

Acoustic echo cancellation is a critical component in videoconferencing and telepresense applications. It guarantees clear audio delivery between participating studios. Studio is a general term meaning a ‘node’ involved in the conference. Videoconferencing is a term which describes a conference between two or more parties that are physically separated and are communicating with each other by means of electronic audio and video. Telepresence is a similar concept that attempts to simulate being in a different physical location utilizing electronic audio and video, and additionally providing a means to manipulate the remote environment.

Acoustic echo cancellation (AEC) is a very important component of any modern videoconferencing or telepresence system. AEC guarantees clear audio for all participants of a videoconference or telepresence session. One type of acoustic echo cancellation system is a hardware system, which detects an acoustic echo in an audio system and attempts to remove the echo or diminish its affect as much as possible. However, current hardware only solutions, once deployed, cannot be modified without upgrading the equipment.

### BRIEF DESCRIPTION OF THE DRAWINGS

FIG. 1 illustrates a videoconferencing or telepresence system 100 implemented in a host machine in one embodiment.

FIG. 2 represents an overview of a videoconferencing or telepresence system with two participating studios in one embodiment.

FIG. 3 is a block diagram representing a studio participating in a videoconference or telepresence session, utilizing one embodiment of the software acoustic echo cancellation system.

FIG. 4 is a flow chart detailing the process of pre-defining and utilizing an audio topology configuration mode in one embodiment.

FIG. 5 is a flow diagram representing the subsystems of a studio participating in a videoconferencing or telepresence session, in which the topology of the conference does not change during the conference in one embodiment.

FIG. 6 is a flow diagram representing the subsystems of a studio participating in a videoconferencing or telepresence session, in which the topology of the conference changes during the conference in one embodiment.

### DETAILED DESCRIPTION OF PREFERRED EMBODIMENT

In the following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

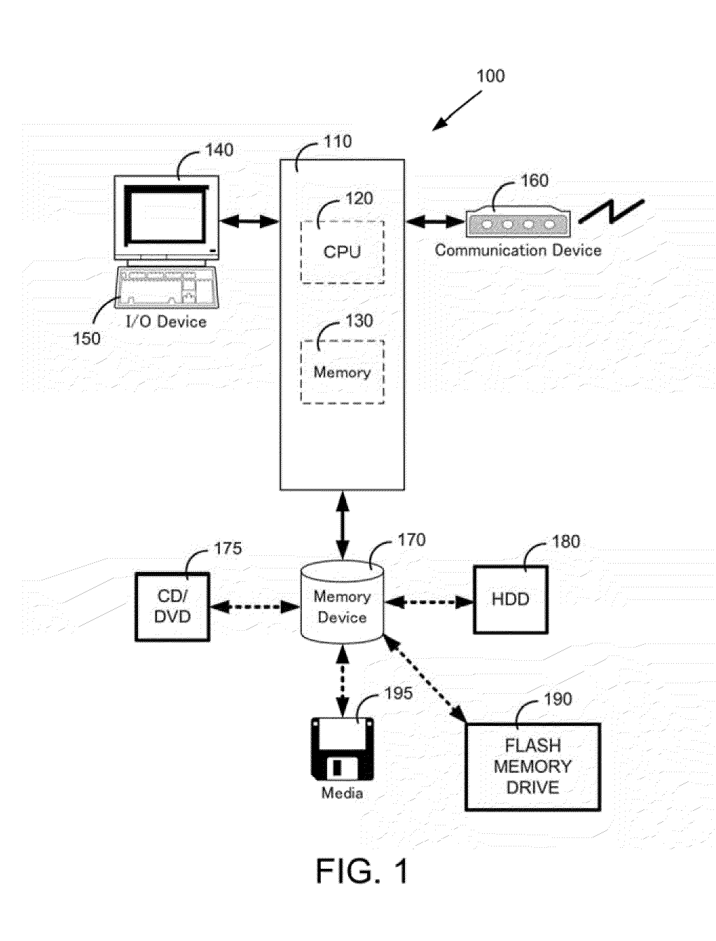

FIG 1. illustrates a videoconferencing or telepresence system 100 in a host machine in one embodiment of the present invention. The host machine includes a main computer 110 with a CPU 120 and memory 130, I/O devices with display device 140, key board 150 and so on, communication deice 160 and memory devices 170 with CD/DVD 175, hard disk drive (HDD) 180, flash memory drive 190 and floppy drive (FD) 195. At least one of the memory devices 170 includes a software-based acoustic cancellation (SWAEC) system that runs on the videoconferencing or telepresence system 100.

Acoustic cancellation (AEC) is an important component of any modern videoconferencing or telepresence system. AEC helps produce clear audio for all participants of a videoconference or telepresence session. AEC can be accomplished in a number of different ways. In one embodiment of the present invention, a software-based acoustic echo cancellation (SWAEC) system is described with virtually unlimited programmability in response to changes in topology of a videoconferencing or telepresence session. The SWAEC is highly configurable and adapts to audio I/O requirements by simply adding input/output ports for additional signal paths, which will be described in detail below.

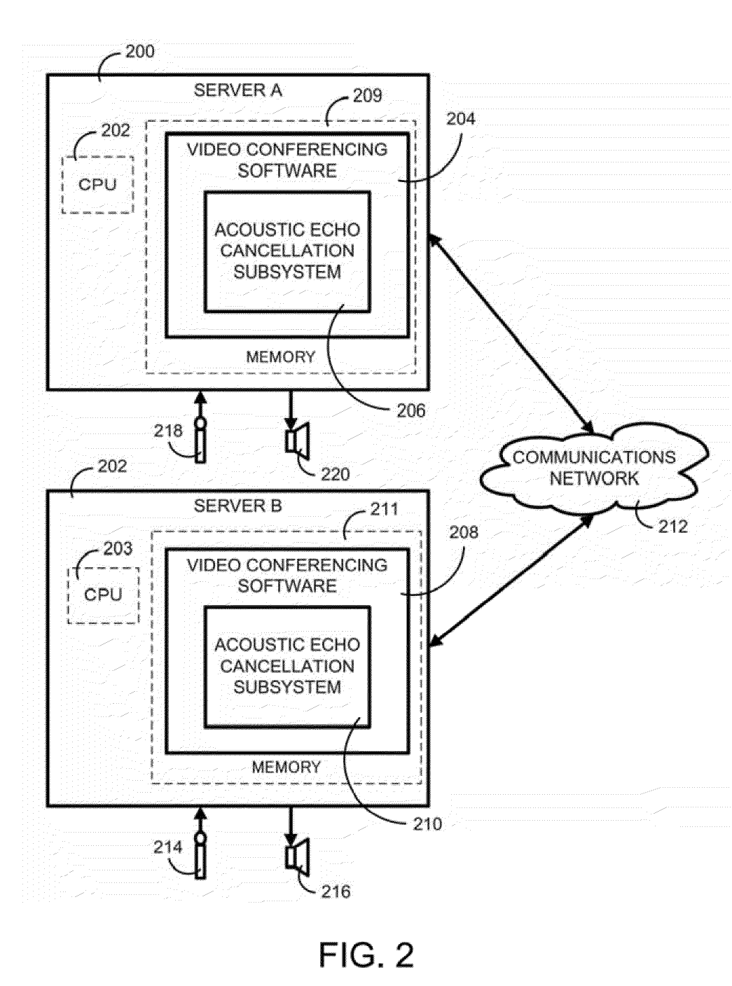

FIG. 2 represents an overview of one embodiment of a videoconferencing or telepresence system. Acoustic echo cancellation systems 204 and 208 of respective memory devices 209 and 211, can use and integrate software acoustic echo cancellation (SWAEC) subsystems 206 and 210 of one embodiment of the present invention for use in both servers 200 and 202 including respective CPUs 202 and 203 and having existing video conference systems operating on them. The SWAEC subsystems 206 and 210 are cost effective, flexible, configurable and maintainable.

In one embodiment as shown in FIG. 2, a session with two participating studios can be performed. In general, server 200 at the first location is a computer running the video conferencing software 204. One embodiment of the AEC subsystem 206 of the present invention is utilized by the video conferencing software 204 to provide echo cancellation during the conference. Server 100 is connected to network 212, which can be a private intranet, the internet, a telephone network, or other type of communications network. Video conferencing software 204 utilizes network 212 to communicate with other studios participating in the video conference session. Microphone 218 and speaker 220 are connected to server 200. Audio signals flowing into microphone 218 are processed by video conferencing software 204 and the AEC subsystem 206.

In one embodiment, server 202 at the second location is also running video conferencing software SWAEC 208. SWAEC subsystem 210 is also utilized by video conferencing software 208. Server 202 is also connected to network 212 and utilizes the network to communicate with other studios participating in the conference session. Microphone 214 and speaker 216 are connected to server 202. Audio signals flowing into microphone 214 are processed by video conferencing software 208 and the SWAEC subsystem 206.

The video conferencing software systems 204 and 208 running on servers 200 and 202, respectively, are easily upgraded by SWAEC subsystems 206 and 210 to continuously encode analog audio signals entering their respective microphones 218 and 214 into a stream of digital data which they transmit to each other over network 212. Upon receiving the encoded digital audio data, video conferencing software 204 and 208 convert the data back into an analog audio signal and send it to their respective speakers 220 and 216.

In general, during the continuous processing of audio, SWAEC subsystems 206 and 210 analyze the audio signals entering respective microphones 220 and 216, as well as audio coming from the remote studio. A correction signal is generated by the SWAEC subsystems 206 and 210, which is delivered to video conferencing software 204 and 208 respectively. This correction signal is applied to the audio data stream by the video conferencing software to eliminate echo in the audio.

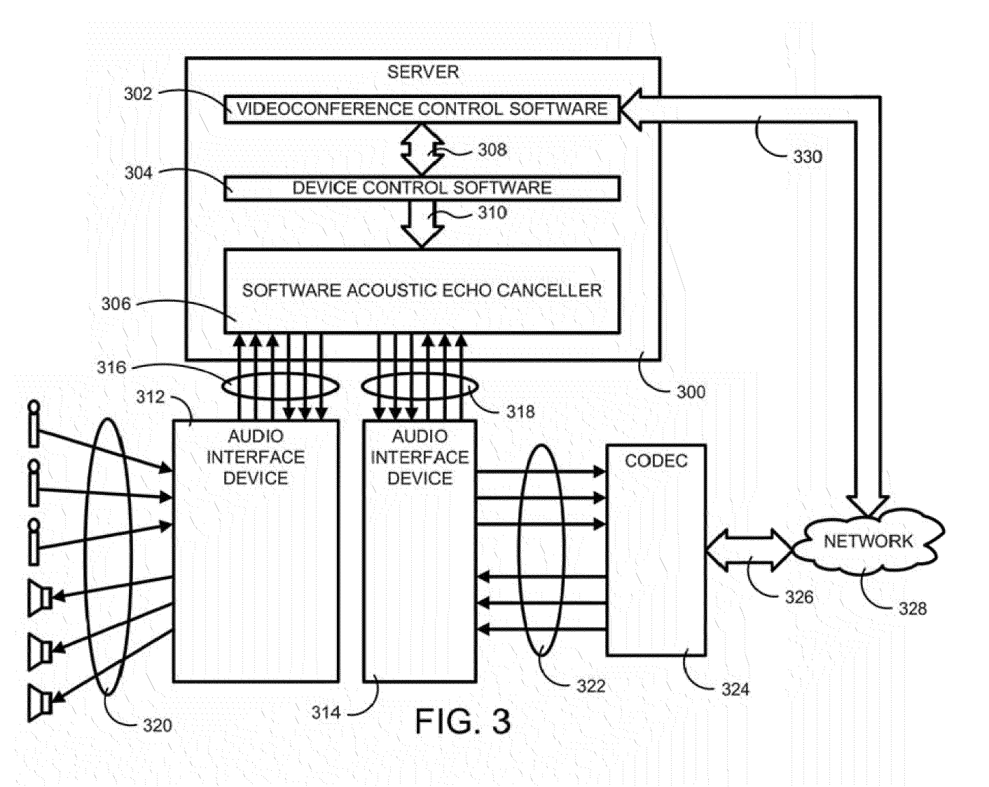

FIG. 3 is a block diagram representing a studio or site participating in a videoconference or telepresence session, utilizing one embodiment of the present invention, namely the SWAEC subsystem. A server or computer system 300 includes a database storing a plurality of mode definitions that are each defined by a video conference session configuration.

Server 300 is running video conferencing software 302. Server 300 is also running device control software 304, which provides videoconferencing software 302 with the application programming interface (API) 308 to software acoustic echo cancellation (SWAEC) subsystem 306. Device control software 304 communicates with the SWAEC subsystem 306 through its API 310. The SWAEC subsystem 306 communicates with two separate audio interface devices 312 and 314 using communications channels 316 and 318 respectively. Communications channels 316 and 318 can be Universal Serial Bus (USB), Fire Wire, Ethernet, or some other means of data communications.

The SWAEC subsystem 306, utilizes audio interface device 312 to communicate with audio I/O devices 320 which are connected to audio interface device 312. Audio inputs at interface 320 can be a microphone, or some other audio input device. Audio outputs at interface 320 can be speakers, headphones, or some other audio output device. The SWAEC subsystem 306 in this example utilizes audio interface 314 to communicate with audio codec 324 using digital audio channel 322. Digital audio signals travel over interface 322 to and from audio compression/decompression (codec) 324. The purpose of the codec is to encode the audio stream into a format that consumes less bandwidth, and also prepares the audio signals for transmission over a digital communications network. Data stream 326 represents the encoded audio data. Encoded audio data 326 is sent and received from network 328 which is used to communicate the compressed audio data to and from other participants of the videoconferencing or telepresence session.

SWAEC subsystem 306 continuously analyzes audio data from inputs at interface 320 as well as incoming audio from interface 322 and uses an analytical detection and correction algorithm to detect echoes, and generate a correction signal which it applies to the audio at outputs 322. The correction signal is combined with the audio stream, and designed to eliminate echo from the audio.

Utilizing SWAEC 306, server 300 is configured to receive an indication of a current video conference configuration and to select a mode definition from the database in server 300 based upon the current configuration, and to configure echo cancelation based on the mode definition. In doing so the server 300 removes echo signals from digitized audio signals based upon the current mode configuration.

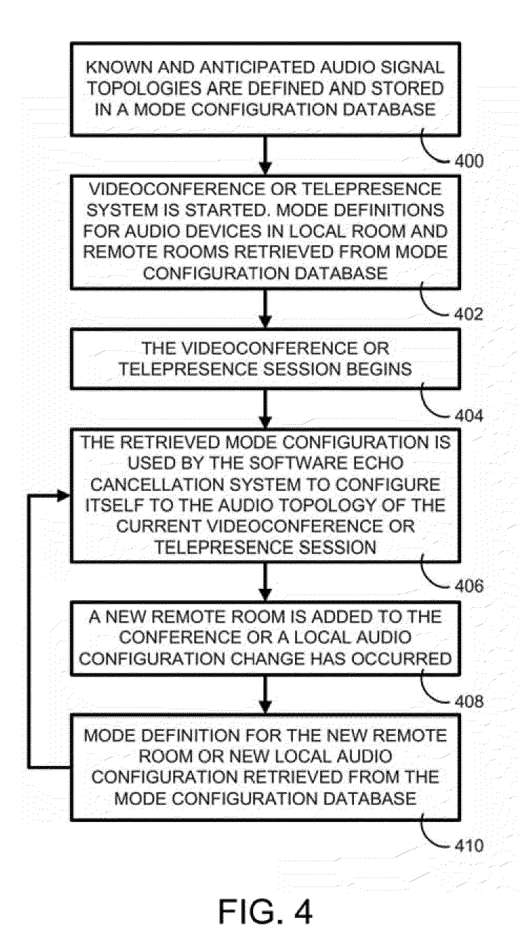

Each mode definition from the database of server 300 is defined by a particular conference session configuration. A conference session configuration encompasses aspects of the video conference session including one or more of (1) which remote site(s) are involved in the session, (2) the properties and/or settings of audio input and output devices used in the session, (3) the placement locations of the audio input and output devices used in the session, to name a few. Operation of the modes will be described with reference to FIGS. 4-6 below.

Thus software-based acoustic echo cancellation (SWAEC) subsystem 306 operating on server 300 offers nearly unlimited programmability and is configured to respond to changes in a videoconferencing or telepresence session topology. The architecture of the SWAEC subsystem 306 of the present invention and its knowledge of its audio paths is completely configurable, which is related to the availability of physical audio channels.

In one embodiment of the present invention, expansion of the system can be pre-configured and made active as required. The SWAEC 306 subsystem of the present invention has the flexibility to dynamically discover and configure newly introduced audio transducers and audio streams. Any newly introduced audio transducers or audio channels can be incorporated into a videoconferencing or telepresence session by utilizing pre-defined session and node specifications. Using pre-defined session and node specifications, in conjunction with newly introduced audio transducers or audio channels 320, the SWAEC system 306 is able to dynamically configure and implement the proper audio paths. The internal architecture of the SWAEC subsystem 306 is able to process new acoustic responses and adapt to the new audio demands.

FIG. 4 is a flow chart detailing the process of pre-defining and utilizing an audio topology configuration mode in one embodiment of the present invention. Any audio signal topologies or anticipated signal topologies by the videoconferencing or telepresence system are entered into a mode configuration database (step 400). The mode configuration database can be any suitable medium which allows for the storage and retrieval of information, such as a file stored on a local hard drive, or records in a database on a remote server.

At a point later in time, the videoconference or telepresence system is started. The mode definitions for the audio devices in the local room as well as the remote rooms involved in the conference are retrieved from the mode configuration database (step 402). The videoconference or telepresence session begins (step 404). The retrieved mode configuration information is used by the software echo cancellation system to configure itself to the audio topology of the current videoconference or telepresence session (step (406).

At a point later in time, a new room is added to the current conference, or a local audio configuration change occurs (step (408). The mode definition for the audio topology of the new remote room or the new local audio configuration is retrieved from the mode configuration database (step 410). The retrieved mode configuration is again used by the software echo cancellation system to configure itself (step 406).

A new mode can be specified as a new set of audio paths or new session topology, whereby the number or remote systems increases or decreases, or the audio channel delivery type e.g. mom vs. stereo vs. multi-channel, changes in response to a remote studio's architecture. Thus a mode is a known condition that must be pre-defined. However the flexible architecture of the SWAEC system of the present invention can respond to any of these changes as they occur. Additionally, as the videoconference or telepresence topology changes, i.e. remote rooms are added or removed, the processing of the audio channels adapts to the new acoustic signature of the room.

As an example, consider the case where a new remote room is added to an ongoing videoconference or telepresence session. The audio from the newly added room begins to play through a speaker in the local room, thus changing the acoustic signature for the local room. This additional audio path generates new acoustic signals in the local room. The newly introduced acoustic signal needs to be factored into the echo cancellation processing algorithm for the local room. The SWAEC subsystem 306 of FIG. 3 can dynamically detect the newly introduced audio path, eliminating acoustic echoes in the conference which would otherwise be generated by the new audio signal.

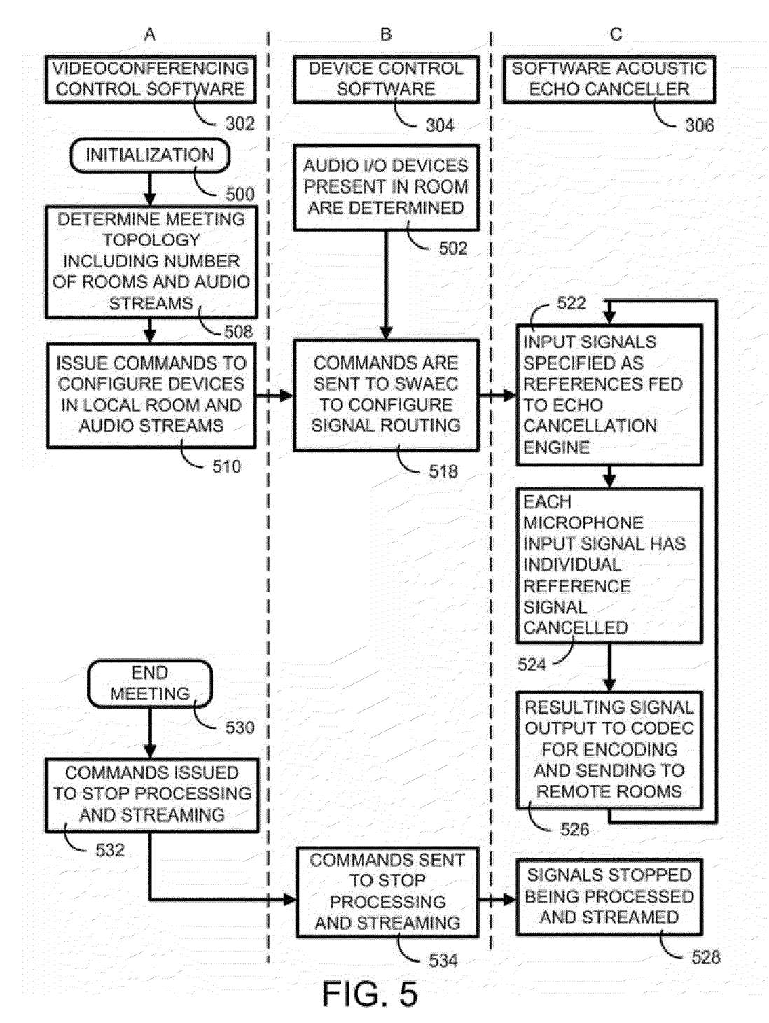

FIG. 5 is a flow diagram representing the subsystems of a studio participating in a videoconferencing or telepresence session, utilizing a preferred embodiment of the present invention, implemented as software based echo cancellation (SWAEC) subsystem 306 of FIG. 3. referring to FIG. 3 along with FIG. 5, Column A represents the execution flow of the videoconferencing or telepresence control software 302. Column B represents the execution flow of the device control software 304. Column C represents the execution flow of the SWAEC subsystem 306.

Upon system initialization (step 500), device control software 304 determines the topology of the audio devices present in the room (step 502). At some point after system initialization, a videoconference/telepresence session is started by the videoconference/telepresence software 302. The meeting topology is determined by the videoconferencing/telepresence software 302, including the number of rooms (studios) and number of audio streams that will be involved in the conference (step 508). Commands are issued to device control software 304 to configure the audio devices in the local room as well as the audio streams in use by the conference (step 510). Upon reception of the commands, device control software 304 sends required commands to the SWAEC 306 to configure signal routing (step 518).

Referring to the SWAEC 30, upon reception of commands (step 518), SWAEC 306 begins a continuous process of feeding input signals specified as references to the echo canceller engine as corrections signals (step 522). Using the correction signals, each microphone input has individual reference signals cancelled (step 524). The resulting audio signal is output to the audio codec for encoding and sending to remote rooms (step 526).

At the end of the videoconferencing/telepresence session (step 530), the videoconferencing/telepresence software issues commands to the device control software 304 to stop audio streaming and processing (step 532). Upon reception of the commands (step 514), device control software 304 issues commands (step 534) to SWAEC 306 to stop processing and streaming. Upon receipt of the commands (step 534), the SWAEC 306 stops processing the audio signals (step 528).

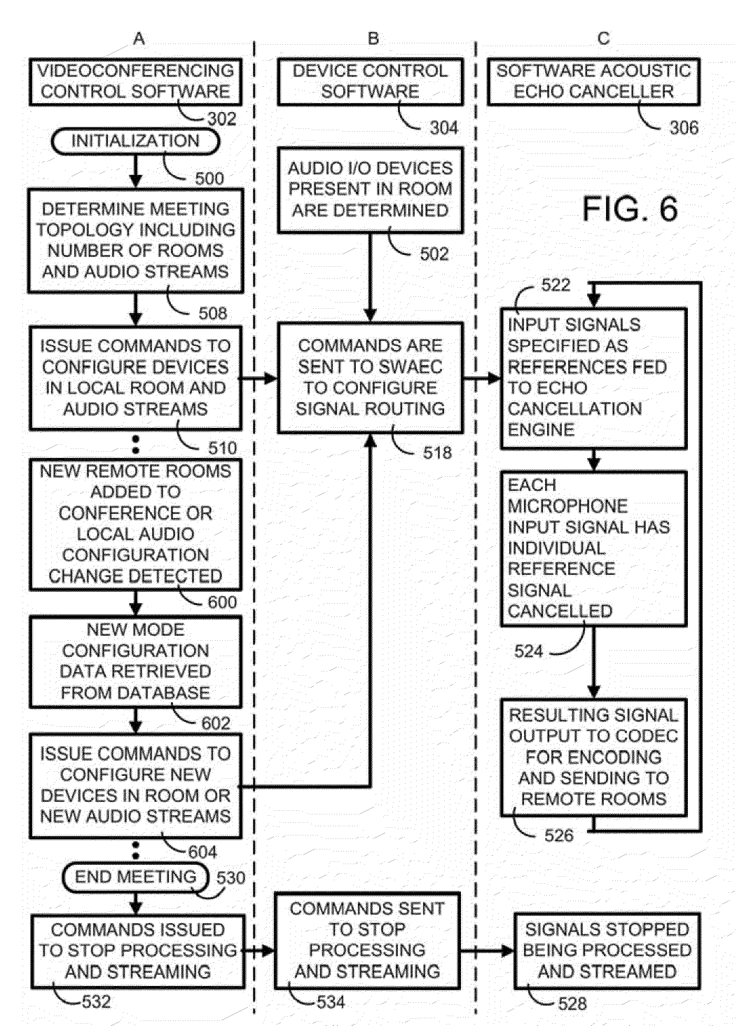

FIG. 6 is a flow diagram representing the subsystems of a studio participating in a videoconferencing or telepresence session utilizing a preferred embodiment of the present invention, implemented with a software based echo cancellation subsystem. Referring to FIG. 3 along with FIG. 6, FIG. 6 represents the same videoconference or telepresence session as depicted in FIG. 5, with the addition of the steps which handle an audio topology change during the conference.

During the course of the videoconference or telepresence session, there might be a change in the local audio topology, such as an additional microphone, or speaker. Or there might be an additional room introduced into the session. When this topology change is detected during the conference, the mode configuration data for the newly detected configuration is retrieved from the mode configuration database (step 602). The video conferencing software 302 issues commands to the device control software 304 to configure the new devices in the room, or the new audio streams coming from the newly added rooms (step 604). Upon reception of these commands, device control software 304 issues commands to the SWAEC 306 to re-configure its signal routing to align with the new audio topology (step 518).

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by worker skilled in the art without departing from the scope of the present invention as defined by the following claims.

What is claimed is:

1. An audio conferencing system for a computer system, comprising:
a database configured to store a plurality of mode definitions each indicative of a video conference session configuration; and
an acoustic canceling subsystem configured to operate on the computer system and having an initial configuration configured to run during a video conferencing session;
wherein the acoustic canceling subsystem is configured to make an acoustic change to a new acoustic configuration of the video conferencing system during the session;
wherein the acoustic canceling subsystem is configured to select a mode definition from the database based upon the new acoustic configuration;
wherein the acoustic echo canceling system is configured to dynamically reconfigure based upon the new acoustic configuration during the session.

2. The audio conferencing system of claim 1 wherein the acoustic change is based upon one or more of:
(1) a remote site added to the session;
(2) a remote site removed from the session; and
(3) the audio configuration of a site involved in the session is changed.

3. The audio conferencing system of claim 1 wherein a host server is configured to operate the acoustic canceling subsystem for remote devices.

4. The audio conferencing system of claim 1 wherein the computer system includes:
videoconferencing control software configured to communicate with the acoustic canceling subsystem; and
device control software coupled to the videoconferencing control software.

5. The audio conferencing system of claim 1 further comprising:
an audio interface device coupled to the computer by a communication channel.

6. The audio conferencing system of claim 5 wherein the audio interface device includes two audio interface devices including a first audio interface device coupled to a plurality of audio input and output devices and a second audio interface device coupled to an audio codec, wherein the computer is configured to receive the digitized audio signals from the first audio interface device and to pass filtered digitized audio signals having the echo signals removed to the second audio interface device.

7. The audio conferencing system of claim 5 wherein the audio interface device includes two audio interface devices including a first audio interface device coupled to a plurality of audio input and output devices and a second audio interface device coupled to an audio codec the computer is configured to receive the digitized audio signals from the second audio interface device and to pass filtered digitized audio signals having the echo signals removed to the first audio interface device.

8. A computer-readable program in a computer-readable medium for a video conference session between two or more sites comprising:
an acoustic echo canceling subsystem;
a database configured to have a plurality of mode definitions and predefined current acoustic configurations stored therein; and
an initial mode definition configured to be selected from the database based upon the current acoustic configuration;
wherein the acoustic echo canceling subsystem is configured based upon the initial mode definition;
wherein the acoustic echo canceling subsystem is configured to receive information defining an acoustic change to a new acoustic configuration during the video conferencing session;
wherein the acoustic echo canceling subsystem is configured to select a new mode definition based upon the acoustic change;
wherein the acoustic echo canceling system is configured to dynamically reconfigure based upon the new mode definition.

9. The computer-readable program of claim 8 wherein the acoustic change is based upon the additional or terminated participation of one of the sites during the conferencing session.

10. The computer-readable program of claim 8 wherein the acoustic change is based upon a change in the audio topology of input and output transducers used during the session.

11. The computer-readable program of claim 8 wherein the acoustic change is based upon a change in physical configuration of audio input and output devices at one of the sites.

12. The computer-readable program of claim 8 wherein the acoustic change is based upon a change in settings of audio input and output devices at one of the sites.

13. The computer-readable program of claim 8, wherein the acoustic echo canceling subsystem is configured to receive input reference signals, a digitized microphone signal and remove the reference signals from the microphone signal based upon configuring the echo based cancellation system.

14. The computer-readable program of claim 8, wherein the acoustic echo canceling subsystem is configured to receive an input signal from a first audio interface device, remove reference signals from the input signal based upon configuring the echo based cancellation system to provide a filtered signal and transmit the filtered signal to a second audio interface device that is coupled to a codec.

15. A computer recordable medium configured to execute instructions for a video conferencing session, the instructions causing the following steps to occur comprising:
providing an acoustic canceling subsystem;
configuring the acoustic echo canceling subsystem based upon an initial mode definition stored in a database;
receiving information indicative of a change in an acoustic configuration of an active video conferencing session;
selecting a new mode definition from the database based upon the change in acoustic configuration; and
dynamically changing the configuration of the acoustic canceling system based upon the new mode definition.

16. The computer-readable program of claim 15 wherein the change in the acoustic configuration is based on one or more of: (1) remote sites engaged in the video conferencing session, (2) properties of audio input and output devices used by the local video conferencing system during the video conferencing session, (3) and placement of locations of the audio input and output devices used by the local video conferencing system during the video conferencing session.

17. The computer-readable program of claim 15 wherein the programming instructions are operating on a host server running the acoustic canceling subsystem for remote devices.

18. The computer-readable program of claim 17 wherein before initial operation, the programming instructions are further configured to interface with other software installed on the video conferencing system, the other software including videoconference control software that is configured to manage the video conference session.

19. The computer-readable program of claim 17, wherein before initial operation, the programming instructions are further configured to interface with other software installed upon the video conferencing system, the other software including: (1) device control software configured to control input and output devices in the local video conferencing system and (2) videoconferencing control software configured to manage the video conferencing session.

20. The computer-readable program of claim 15 wherein the programming instructions are further configured to remove echo signals from a digitized microphone signal based upon the new mode definition.
